(19) United States
(12) Patent Application Publication
(10) Pub. No.: US 2026/0009520 A1
(43) Pub. Date: Jan. 8, 2026

(54) LIGHT-EMITTING LAMP STRUCTURE WITH DIFFUSE REFLECTION

(71) Applicant: Xiamen Topstar Lighting Co., Ltd., Xiamen (CN)

(72) Inventors: Yongjie WU, Xiamen (CN); Yunbiao WU, Xiamen (CN)

(73) Assignee: Xiamen Topstar Lighting Co., Ltd., Xiamen (CN)

(21) Appl. No.: 19/325,410

(22) Filed: Sep. 10, 2025

(30) Foreign Application Priority Data
Jul. 29, 2025 (CN) 202521594658.X

(51) Int. Cl. F21V 7/04; F21V 15/015; F21V 17/06; F21V 19/00; F21V 23/04; F21V 29/71; F21Y 107/70; F21Y 115/10

(52) U.S. Cl. CPC F21V 7/04; F21V 15/015; F21V 17/06; F21V 19/0035; F21V 23/04; F21V 29/713; F21Y 2107/70; F21Y 2115/10

(57) ABSTRACT

A light-emitting lamp structure with diffuse reflection includes: a reflector cup having a run-through mounting hole; a heat dissipation assembly, at least a part of the heat dissipation assembly being provided inside the reflector cup through the mounting hole; and a light source assembly provided inside the reflector cup along a side wall of the heat dissipation assembly. By providing the mounting hole in the reflector cup, a part of the heat dissipation assembly is provided inside the reflector cup through the mounting hole, so that the light source assembly is provided along the side wall of the heat dissipation assembly, thereby facilitating assembly between the light source assembly and the heat dissipation assembly while avoiding glare caused by direct downward light emission from the light source assembly.

### CROSS-REFERENCE TO RELATED APPLICATIONS

This application claims priority to Chinese Patent Application No. 202521594658.X, filed on Jul. 29, 2025, the contents of which are incorporated herein by reference.

### TECHNICAL FIELD

The present disclosure relates to the technical field of lamps, and more particularly relates to a light-emitting lamp structure with diffuse reflection.

### BACKGROUND

In the existing lamp field, the problem of glare may be caused by adopting direct downward light emission. In order to solve the problem of glare, light is generally emitted through diffuse reflection. However, when the light is emitted by adopting diffuse reflection, a light source cannot be assembled with direct downward light emission, thereby resulting in the problem that light source is difficult to assembly. The statements herein only provide background information related to the present disclosure and do not necessarily constitute the prior art.

### SUMMARY

A light-emitting lamp structure with diffuse reflection, includes: a reflector cup having a run-through mounting hole; a heat dissipation assembly, at least a part of the heat dissipation assembly being provided inside the reflector cup through the mounting hole; and a light source assembly provided inside the reflector cup along a side wall of the heat dissipation assembly.

### BRIEF DESCRIPTION OF THE DRAWINGS

FIG. 1 is an overall assembly view of a partial structure of a light-emitting lamp structure with diffuse reflection according to one or more examples.

FIG. 2 is an exploded view of a partial structure of the light-emitting lamp structure with diffuse reflection according to one or more examples.

FIG. 3 is an exploded view of an entire lamp structure of the light-emitting lamp structure with diffuse reflection according to one or more examples.

FIG. 4 is an assembly view of the entire lamp structure of the light-emitting lamp structure with diffuse reflection according to one or more examples.

FIG. 5 is a cross-sectional view of the light-emitting lamp structure with diffuse reflection according to one or more examples.

FIG. 6 is a schematic structural view of a transparent protective shade of the light-emitting lamp structure with diffuse reflection according to one or more examples.

FIG. 7 is a schematic structural view of a cover plate of the light-emitting lamp structure with diffuse reflection according to one or more examples.

FIG. 8 is a schematic structural view of an outer side of a housing of the light-emitting lamp structure with diffuse reflection according to one or more examples.

### DETAILED DESCRIPTION OF THE EMBODIMENTS

In order to provide a detailed explanation of the technical contents, and the achieved objects and effects of the present disclosure, the following description is provided in conjunction with the embodiments and accompanying drawings.

A light-emitting lamp structure with diffuse reflection, includes: a reflector cup 1 having a run-through mounting hole 11; a heat dissipation assembly 2, at least a part of the heat dissipation assembly 2 being provided inside the reflector cup 1 through the mounting hole 11; and a light source assembly 3 provided inside the reflector cup 1 along a side wall of the heat dissipation assembly 2. By providing the mounting hole 11 in the reflector cup 1, a part of the heat dissipation assembly 2 is provided inside the reflector cup 1 through the mounting hole 11, so that the light source assembly 3 is provided along the side wall of the heat dissipation assembly 2, thereby facilitating assembly between the light source assembly 3 and the heat dissipation assembly 2 while avoiding glare caused by direct downward light emission from the light source assembly 3.

In some examples, the heat dissipation assembly 2 includes a horizontal mounting portion 21 and a protruding mounting portion 22; and the light-emitting lamp structure further includes a driver 4 provided on the horizontal mounting portion 21 and provided with a through hole 41; the protruding mounting portion 22 passes through the through hole 41 and the mounting hole 11, so that at least a part is provided inside the reflector cup 1. The heat dissipation assembly 2 is provided to include the horizontal mounting portion 21 and the protruding mounting portion 22, and an avoidance hole is provided in the driver 4, so that the driver 4 is provided on the horizontal mounting portion 21, and the light source assembly 3 is provided through the protruding mounting portion 22, so that both the light source assembly 3 and the driver 4 are provided on the heat dissipation assembly 2, thereby not only improving the overall heat dissipation effect, but also facilitating wiring between the light source assembly 3 and the driver 4 to form electrical connection.

In some examples, the horizontal mounting portion 21 is provided with a first positioning member 23; and the driver 4 is provided with a second positioning member 42 adapted to the first positioning member 23. By providing the first positioning member 23 on the horizontal mounting portion 21 and correspondingly providing the second positioning member 42 on the driver 4 respectively, through the cooperation between the first positioning member 23 and the second positioning member 42, it is easier to mount the driver 4 on the heat dissipation assembly 2, and the stability of the driver 4 is improved.

In some examples, the light source assembly 3 includes a flexible light source board 31; the protruding mounting portion 22 is a column body; and the flexible light source board 31 is provided on a side surface of the protruding mounting portion 22. The flexible light source board 31 is adopted as the light source assembly 3, and the protruding mounting portion 22 is provided as the column body, so that the flexible light source board 31 is attached to the side surface of the protruding mounting portion 22, and the light source assembly 3 is easier to mount.

The protruding mounting portion 22 is a cylindrical body; and light sources 32 on the flexible light source board 31 are provided at equal intervals. The light sources 32 on the flexible light source board 31 are light emitting diodes (LEDs). By providing the protruding mounting portion 22 as the cylindrical body and providing the light sources 32 on the flexible light source board 31 at equal intervals, light is uniformly emitted onto the reflector cup 1, thereby improving the light emission effect.

In some examples, the light-emitting lamp structure further includes a cover plate 5; wherein the cover plate 5 is provided at a top of the protruding mounting portion 22 and covers the protruding mounting portion 22. By providing the cover plate 5 at the top of the protruding mounting portion 22, the effect of shielding the light source assembly 3 and the heat dissipation assembly 2 is achieved.

In some examples, one side of the cover plate 5 close to the protruding mounting portion 22 is provided with a snap fastener 51; the top of the protruding mounting portion 22 is provided with a snap slot 221; and the snap fastener 51 is detachably connected to the snap slot 221. By providing the snap fastener 51 on the cover plate 5 and providing the snap slot 221 in the protruding mounting portion 22, the cover plate 5 is provided on the protruding mounting portion 22 through the cooperation between the snap fastener 51 and the snap slot 221.

In some examples, an inner side of the reflector cup 1 is a diffuse reflection surface. By providing the inner side of the reflector cup 1 as the diffuse reflection surface, light is emitted in a diffuse reflection manner, thereby avoiding the problem of glare.

In some examples, the light-emitting lamp structure further includes a transparent protective shade 6; wherein the transparent protective shade 6 is provided around the light sources 32 of the light source assembly 3. By providing the transparent protective shade 6 around the light sources 32 of the light source assembly 3, the light sources 32 on the light source assembly 3 are isolated from other components, thereby preventing contact with the charged light sources 32.

In some examples, one side of the transparent protective shade 6 away from the light source assembly 3 is provided with a refractive structure 61. By adding the refractive structure 61, light is better refracted to the reflector cup.

In some examples, the light-emitting lamp structure further includes a housing 7; wherein the housing 7 is provided with a mounting slot 78; and both the reflector cup 1 and the light source assembly 3 are provided inside the mounting slot 78. By providing the mounting slot 78 inside the housing 7, the reflector cup 1 and the light source assembly 3 are effectively protected through the housing 7.

In some examples, a plane of a slot opening of the mounting slot 78 is not lower than a plane of a cup opening of the reflector cup 1. By enabling the plane of the slot opening of the mounting slot 78 to be not lower than the plane of the cup opening of the reflector cup 1, the heights of the heat dissipation assembly 2 and the light source assembly 3 are both lower than the plane of the slot opening, thereby enabling a light-emitting surface to be closer to the reflector cup 1 and achieving better diffuse reflection.

In some examples, the housing 7 is provided with a dip switch 8. By connecting the dip switch 8 to a circuit on the driver 4, the control of the lamp is achieved.

In some examples, the reflector cup 1 is in threaded connection with the housing 7. The threaded connection between the reflector cup 1 and the housing 7 not only facilitates the connection between the reflector cup 1 and the housing 7, but also enhances the stability of the reflector cup 1.

In some examples, an outer side of the housing 7 is provided with a mounting assembly 9. By providing the mounting assembly 9 on the outer side of the housing 7, the lamp is mounted through the mounting assembly 9.

In some examples, the mounting assembly 9 includes amounting fastener 91 and a torsion spring 92; the mounting fastener 91 is provided on an outer side wall of the housing 7; and a main body 921 of the torsion spring 92 is provided inside the mounting fastener 91, and an elastic arm 922 of the torsion spring 92 is provided outside the mounting fastener 91. By providing the mounting fastener 91 on the outer side wall of the housing 7 and fixing the main body 921 of the torsion spring 92 through the mounting fastener 91, the elastic arm 922 of the torsion spring 92 elastically deforms by taking the main body 921 as a center, so as to complete the mounting through the elastic deformation of the torsion spring 92 during an actual mounting process.

In some examples, the reflector cup 1 is formed through injection molding. By forming the reflector cup 1 through injection molding, the weight of the reflector cup 1 is lighter.

In some examples, an inner surface of the reflector cup 1 is formed with a coarse matte texture through abrasive blasting. On the basis of injection molding, the inner surface of the reflector cup 1 is treated with the coarse matte texture by abrasive blasting, thereby forming the diffuse reflection surface on a plastic surface.

In some examples, the reflector cup 1 is formed through metal spinning. By forming the reflector cup 1 through metal spinning, metal has a better heat dissipation effect, thereby improving the overall heat dissipation performance of the lamp.

In some examples, the inner surface of the reflector cup 1 is formed through sandblasting. On the basis of metal spinning, sandblasting is performed on the inner surface of the reflector cup 1 to form the diffuse reflection surface on a metal surface.

The light-emitting lamp structure with diffuse reflection provided in the present disclosure is applied to lamps of lamp models such as a downlight, and the following is an explanation through specific embodiments.

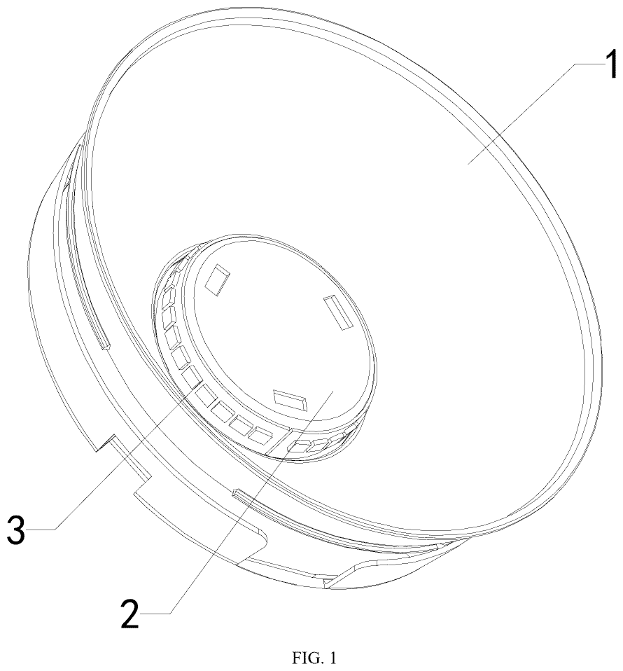

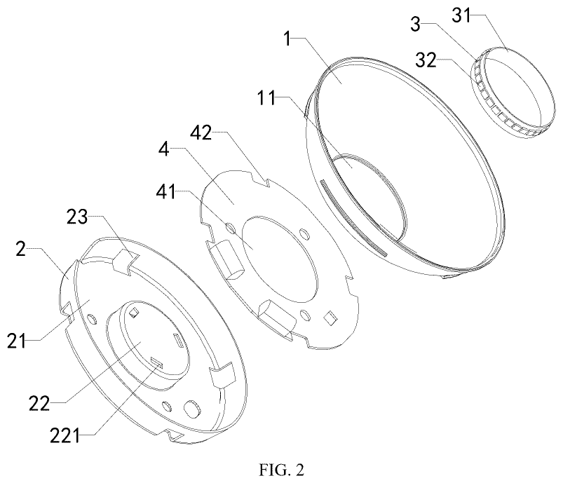

In some examples, referring to FIG. 1 and FIG. 2, a light-emitting lamp structure with diffuse reflection, includes: a reflector cup 1 having a run-through mounting hole 11; a heat dissipation assembly 2, at least a part of the heat dissipation assembly 2 being provided inside the reflector cup 1 through the mounting hole 11; and a light source assembly 3 provided inside the reflector cup 1 along a side wall of the heat dissipation assembly 2, wherein an inner side of the reflector cup 1 is a diffuse reflection surface, and wherein the reflector cup 1 is formed through injection molding, and the inner surface of the reflector cup 1 is treated with the coarse matte texture by abrasive blasting, thereby forming the diffuse reflection surface. Or the reflector cup 1 is formed through metal spinning, and sandblasting is performed on the inner surface of the reflector cup 1 to form the diffuse reflection surface.

As shown in FIG. 2, the heat dissipation assembly 2 includes a horizontal mounting portion 21 and a protruding mounting portion 22; and the lamp structure further includes a driver 4 provided on the horizontal mounting portion 21 and provided with a through hole 41; the protruding mounting portion 22 passes through the through hole 41 and the mounting hole 11, so that at least a part is provided inside the reflector cup 1, wherein the horizontal mounting portion 21 is provided with a first positioning member 23; and the driver 4 is provided with a second positioning member 42 adapted to the first positioning member 23, thereby forming positioning cooperation through the first positioning member 23 and the second positioning member 42; for example, in some examples, the first positioning member 23 is a hollow structure, and the second positioning member 42 is an avoidance structure adapted to the hollow structure, with both jointly positioning through a bottom positioning structure of the mounting slot 78. In some other examples, the first positioning member 23 and the second positioning member 42 are mortise and tenon structures cooperating with each other.

In an optional embodiment, the light source assembly 3 includes a flexible light source board 31; the protruding mounting portion 22 is a column body; the flexible light source board 31 is provided on a side surface of the protruding mounting portion 22, and the height of the protruding mounting portion 22 is higher than the height of the flexible light source board 31; and in a more preferred embodiment, the protruding mounting portion 22 is a cylindrical body, and the light sources 32 on the flexible light source board 31 are provided at equal intervals.

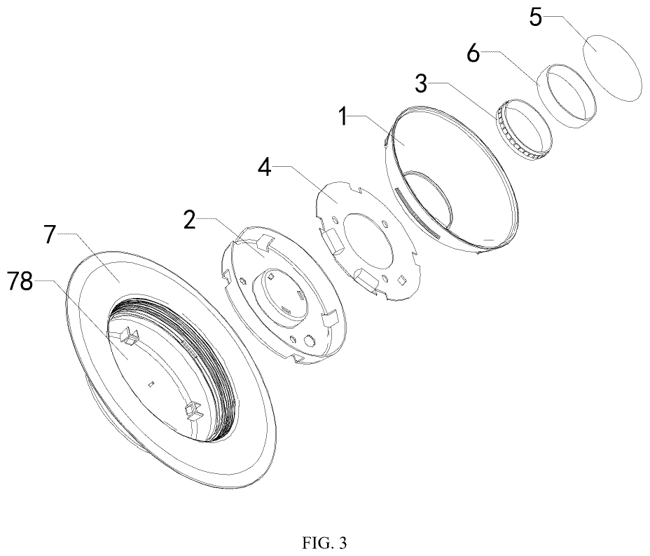

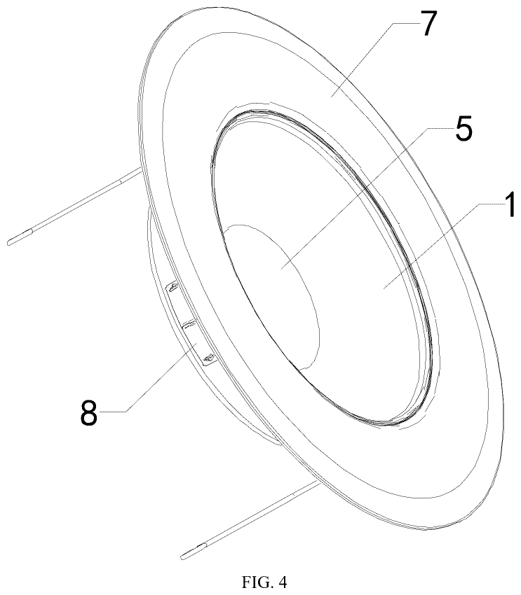

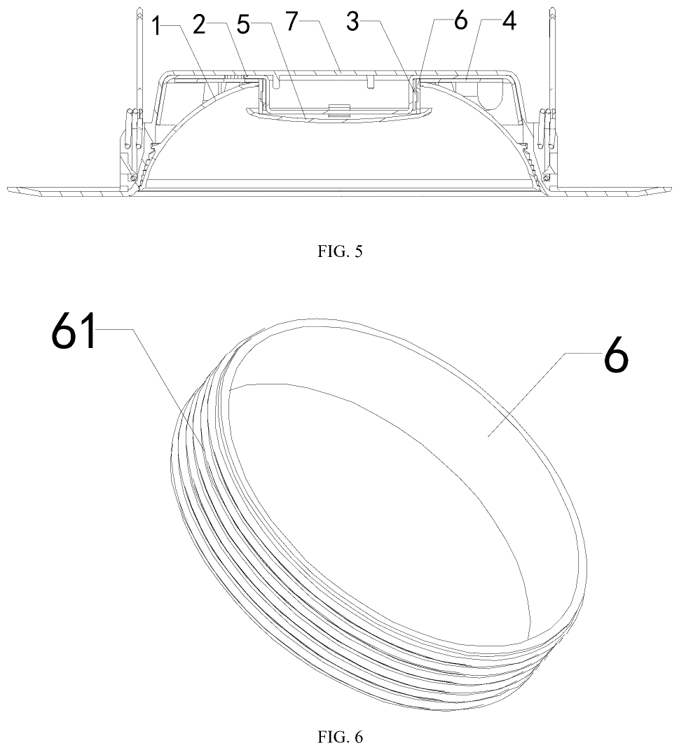

Referring to FIG. 3 to FIG. 5, the lamp structure further includes a cover plate 5, a transparent protective shade 6, and a housing 7; wherein the transparent protective shade 6 is provided around the light sources 32 of the light source assembly 3; as shown in FIG. 6, one side of the transparent protective shade 6 away from the light source assembly 3 is provided with a refractive structure 61; and as shown in FIG. 3, the light source assembly 3 is of an annular structure, and the transparent protective shade 6 is also of the annular structure and is provided on an outer side of the light source assembly 3. The cover plate 5 is provided at a top of the protruding mounting portion 22, covers the protruding mounting portion 22, and covers the light source assembly 3 and the transparent protective shade 6 simultaneously. The housing 7 is provided with a mounting slot 78; and both the reflector cup 1 and the light source assembly 3 are provided inside the mounting slot 78; a plane of a slot opening of the mounting slot 78 is not lower than a plane of a cup opening of the reflector cup 1; meanwhile, a positioning block is provided at a bottom of the mounting slot 78 for forming positioning cooperation with the first positioning member 23 and the second positioning member 42; and the reflector cup 1 is in threaded connection with the housing 7. In an optional embodiment, the housing 7 is also provided with a dip switch 8. By connecting the dip switch 8 to a circuit on the driver 4, the control of the lamp is achieved.

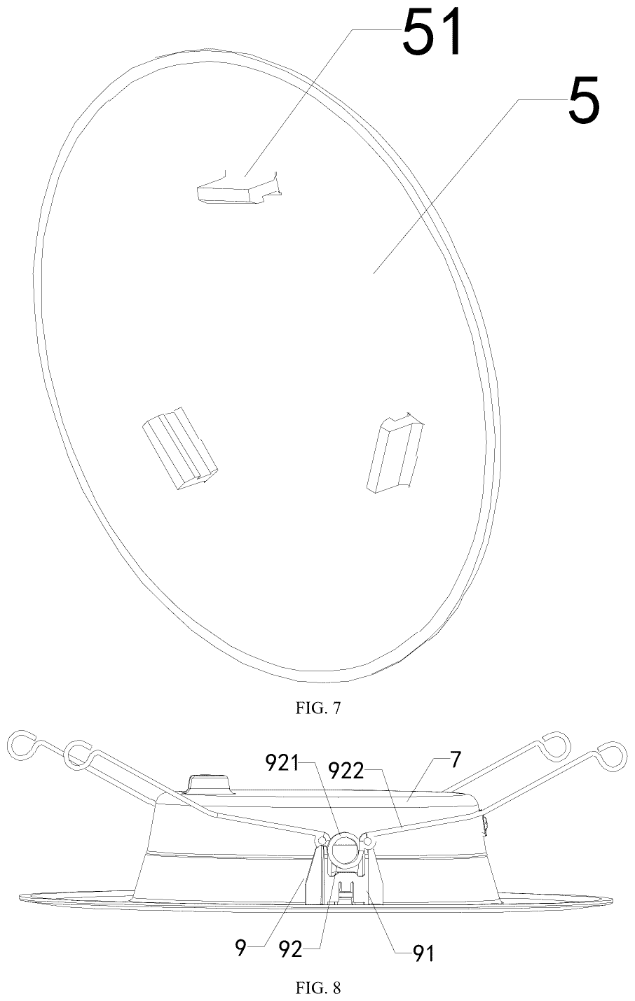

Referring to FIG. 2 and FIG. 7, one side of the cover plate 5 close to the protruding mounting portion 22 is provided with a snap fastener 51; the top of the protruding mounting portion 22 is provided with a snap slot 221; and the snap fastener 51 is detachably connected to the snap slot 221, wherein a total of three snap fasteners 51 are provided on the cover plate 5, and three snap slots 221 are correspondingly provided in the protruding mounting portion 22.

Referring to FIG. 8, an outer side of the housing 7 is provided with a mounting assembly 9; wherein the mounting assembly 9 includes a mounting fastener 91 and a torsion spring 92; the mounting fastener 91 is provided on an outer side wall of the housing 7; and a main body 921 of the torsion spring 92 is provided inside the mounting fastener 91, and an elastic arm 922 of the torsion spring 92 is provided outside the mounting fastener 91. As shown in FIG. 8, a set of mounting assemblies 9 is respectively provided on two sides of the housing 1; and during mounting, the elastic arm 922 of the torsion spring 92 rotates and deforms to the inner side to pass through the mounting hole in the wall, and then the elastic arm 922 of the torsion spring 92 restores after losing the action of an external force, thereby mounting the lamp at a preset position.

The above description is only for the examples of the present disclosure and does not therefore limit the patent scope of the present disclosure. Any equivalent transformation made using the description and accompanying drawings of the present disclosure, or directly or indirectly applied in related technical fields, is similarly included in the patent protection scope of the present disclosure.

What is claimed is:

1. A light-emitting lamp structure with diffuse reflection, comprising:
a reflector cup having a run-through mounting hole;
a heat dissipation assembly, at least a part of the heat dissipation assembly being provided inside the reflector cup through the mounting hole; and
a light source assembly provided inside the reflector cup along a side wall of the heat dissipation assembly.

2. The light-emitting lamp structure with diffuse reflection according to claim 1, wherein the heat dissipation assembly comprises a horizontal mounting portion and a protruding mounting portion;
the light-emitting lamp structure further comprises a driver provided on the horizontal mounting portion and provided with a through hole; and
the protruding mounting portion passes through the through hole and the mounting hole, so that at least a part of the protruding mounting portion is provided inside the reflector cup.

3. The light-emitting lamp structure with diffuse reflection according to claim 2, wherein the horizontal mounting portion is provided with a first positioning member; and
the driver is provided with a second positioning member adapted to the first positioning member.

4. The light-emitting lamp structure with diffuse reflection according to claim 2, wherein the light source assembly comprises a flexible light source board;
the protruding mounting portion is a column body; and
the flexible light source board is provided on a side surface of the protruding mounting portion.

5. The light-emitting lamp structure with diffuse reflection according to claim 4, wherein the protruding mounting portion is a cylindrical body; and
light sources on the flexible light source board are provided at equal intervals.

6. The light-emitting lamp structure with diffuse reflection according to claim 2, further comprising a cover plate;
wherein the cover plate is provided at a top of the protruding mounting portion and covers the protruding mounting portion.

7. The light-emitting lamp structure with diffuse reflection according to claim 6, wherein one side of the cover plate close to the protruding mounting portion is provided with a snap fastener;
the top of the protruding mounting portion is provided with a snap slot; and
the snap fastener is detachably connected to the snap slot.

8. The light-emitting lamp structure with diffuse reflection according to claim 1, wherein an inner side of the reflector cup is a diffuse reflection surface.

9. The light-emitting lamp structure with diffuse reflection according to claim 1, further comprising a transparent protective shade;
wherein the transparent protective shade is provided around the light sources of the light source assembly.

10. The light-emitting lamp structure with diffuse reflection according to claim 9, wherein one side of the transparent protective shade away from the light source assembly is provided with a refractive structure.

11. The light-emitting lamp structure with diffuse reflection according to claim 1, further comprising a housing;
wherein the housing is provided with a mounting slot; and
both the reflector cup and the light source assembly are provided inside the mounting slot.

12. The light-emitting lamp structure with diffuse reflection according to claim 11, wherein a plane of a slot opening of the mounting slot is not lower than a plane of a cup opening of the reflector cup.

13. The light-emitting lamp structure with diffuse reflection according to claim 11, wherein the housing is provided with a dip switch.

14. The light-emitting lamp structure with diffuse reflection according to claim 11, wherein the reflector cup is in threaded connection with the housing.

15. The light-emitting lamp structure with diffuse reflection according to claim 11, wherein an outer side of the housing is provided with a mounting assembly.

16. The light-emitting lamp structure with diffuse reflection according to claim 15, wherein the mounting assembly comprises a mounting fastener and a torsion spring;
the mounting fastener is provided on an outer side wall of the housing; and
a main body of the torsion spring is provided inside the mounting fastener, and an elastic arm of the torsion spring is provided outside the mounting fastener.

17. The light-emitting lamp structure with diffuse reflection according to claim 1, wherein the reflector cup is formed through injection molding.

18. The light-emitting lamp structure with diffuse reflection according to claim 17, wherein an inner surface of the reflector cup is formed with a coarse matte texture through abrasive blasting.

19. The light-emitting lamp structure with diffuse reflection according to claim 1, wherein the reflector cup is formed through metal spinning.

20. The light-emitting lamp structure with diffuse reflection according to claim 19, wherein the inner surface of the reflector cup is formed through sandblasting.
